(19) United States
(12) Patent Application Publication
(10) Pub. No.: US 2016/0334921 A1
(43) Pub. Date: Nov. 17, 2016

(54) ACTIVE POINTING DEVICE DETECTION

(71) Applicant: PROMETHEAN LIMITED, Blackburn Lancashire (GB)

(72) Inventor: Andrew Oakley, Blackburn, Lancashire (GB)

(73) Assignee: Promethean House, Lower Philips Road, Blackbum, Lancashire (GB)

(21) Appl. No.: 15/112,656

(22) PCT Filed: Jan. 20, 2015
(86) PCT No.: PCT/EP2015/051026

§ 371 Date: Jul. 19, 2016

(30) Foreign Application Priority Data
Jan. 20, 2014 (GB) 1400900.5

(51) Int. Cl. G06F 3/041; G06F 3/038; G06F 3/042; G06F 3/0354

(52) U.S. Cl. CPC G06F 3/0416; G06F 3/03545; G06F 3/0383; G06F 3/042

(57) ABSTRACT

The invention provides a method for detecting the presence of a pointing device at an interactive surface.

### BACKGROUND TO THE INVENTION

1. Field of the Invention

The present invention is concerned with touch input detection systems, and the adaptation of such systems to allow for the detection of devices providing pen inputs. The invention particularly provides for distinction between a contact point provided by a touch input and a contact point provided by a pen input.

2. Description of the Related Art

In the following description the expressions ‘touch’ and ‘pen’ are used to refer to two different types of technology for providing a contact point at an interactive surface. In a touch system a contact point may be provided by an object such as a finger, or a device such as a stylus. In a pen system a contact may be provided by an object termed a pen device or a pointing device, which can interact with the system by means other than simply providing a contact point.

Interactive systems incorporating touch and/or pen technology are well-known in the art.

An exemplary touch system is illustrated in FIG. 1. The exemplary system comprises an interactive surface 10, a touch data processor 12, and a computer 14. A touch contact on the interactive surface provided by a finger of a hand 11 is detected, and data associated with that touch contact point provided as DATA in a data stream to the touch data processor 12. The touch data processor 12 processes the data in accordance with known techniques, before forwarding the processed data to the computer 14 for further processing in accordance with known techniques.

Touch systems typically rely on detecting a contact point at the display surface provided by a touch such as a finger contact. Typically touch detection systems have a number of disadvantages in comparison to a system which is arranged to detect a device such as a pen.

In a system arranged to detect a pen it is advantageously possible to distinguish between and identify multiple contact points, because a contact point may be mapped to a unique pen.

In a system arranged to detect a pen it is advantageously possible to distinguish between a contact point on a surface and a hover contact point above the surface, because a contact point may be determined to be at the display surface or proximate to the display surface.

In a system arranged to detect a pen it is advantageously possible to provide automatic switching of modes through the provision of buttons on the pen device.

Systems which are adapted to provide for detection of both touch inputs and pens can provide the benefits of both technologies in a single system. However, such a system may require a user to manually select a menu in order to switch between touch and pen modes.

It is an aim of the present invention to provide adaptations to an interactive system arranged to detect touch inputs to additionally provide for detection of contact points provided by a pen, and moreover to distinguish between a contact provided by a touch and a contact provided by a pen.

### SUMMARY OF THE INVENTION

There is provided a method for detecting the presence of a pointing device at an interactive surface, which interactive surface is arranged to detect a contact point, the method comprising: receiving data representing a contact point;

determining if a wireless signal is received; and in dependence on receipt of a wireless signal identifying said data as touch data or pen data.

The interactive surface may be arranged for detection of a contact point provided by touch inputs.

If a wireless signal is received the data may be identified as pen data. If a wireless signal is not received the data may be identified as touch data. On identification, the data may be transmitted for further processing.

Transmission of said data for further processing of the data may be delayed whilst determination is made as to whether a wireless signal is received.

Identifying the data as touch data or pen data may comprise setting one or more flag bits associated with said data. One or more flag bits may be a single bit, the state of which indicates touch data or pen data.

A pen may be adapted to transmit a wireless signal when it is located within a certain proximity of the interactive surface. For example, the pen may transmit when it is located in an IR field close to the interactive surface. The pen may be energized by the IR field.

The pen may transmit a wireless signal when it is located within a certain proximity of the interactive surface.

A pen may transmit a wireless signal responsive to an interrogation signal.

An interactive system associated with the interactive surface may transmit an infra-red illumination field on the interactive surface, additional to any infra-red signal associated with detection of a contact point, for enabling detection of any pen providing a contact point. A pen may be adapted to detect an infra-red signal associated with said infra-red illumination field. A pen may be energized by an infra-red signal associated with said infra-red illumination field. A pen may transmit a wireless signal upon detection or receipt of said infra-red signal.

The method may identify data associated with multiple contact points as being provided by touch inputs or device inputs, the method further comprising determining a location of any device, and comparing the location of such device to the location of a contact point.

An interface may transmit wireless infra-red signals in a plurality of infra-red transmitters, the signals from the respective infra-red transmitters illuminating the interactive surface with an infra-red illumination field.

The central axis of each infra-red transmitter may be offset from the central axis of each other infra-red transmitter. A pen positioned on the interactive surface may receive a signal from one or more of the infra-red transmitters, and processes the received signals. The pen may be adapted to transmit a signal to the interface, which signal is indicative of a coarse location of the pen. The signal transmitted from the pen may be an indication of the amplitude of the signal received from each transmitter.

The signal transmitted may be modulated by each transmitter with a different frequency. The time offset of each signal may be the same.

The pen may detect a composite signal being the signal detected at least one transmitter. The pen may process the composite signal to provide one or more signals indicating the coarse position of the pen. The one or more signals may be one or more amplitude signals representing the amplitude of the signals received at the pen from each transmitter. The pen may determine a coarse location of the pen based on said signals, and transmit said coarse location to the interface. The pen may transmit the one or more amplitude signals representing the amplitude of the signals received at the pen from each transmitter to the interface. The interface may determine a coarse location for the pen in dependence thereon, and compare said coarse location to an accurate location. The interface may compare the one or more amplitude signals to one or more amplitude signals of tracked positions.

An interface may modulate the signal transmitted by each transmitter with a different time offset. The frequency modulation of each signal may be the same. The pen may detect a signal being the time offset signal transmitted from each transmitter in turn. The method may comprise processing each time offset signal to provide a signal which is used to indicate the coarse position of the pen. The method may comprise generating, by the pen, in a signal sequence for each time offset transmitted signal, to produce one or more amplitude signals. One or more amplitude signals may be used, in accordance with their associated time offset, to determine a coarse location of the pen, and transmit said coarse location to the interface. The pen may transmit the one amplitude signal for each time offset to the interface. The interface may determine a coarse location for the pen in dependence thereon, and compare said coarse location to an accurate location. The interface may compare the one or more amplitude signals to one or more amplitude signals of tracked positions.

There is also provided a method for a device for an interactive display system, the device providing a contact point at an interactive surface of the system, the device receiving a wireless signal, and transmitting a wireless signal responsive to detection of receipt of the wireless signal.

The receipt of the wireless signal may energize the device.

The receipt of the wireless signal may comprise detecting a wireless signal which is provided by the system in addition to a wireless signal for detecting a contact point.

The device may receive a plurality of wireless signals.

The device may determine an approximate position relative to the display surface on detection of the plurality of wireless signals, and provides an indication of said approximate position in the transmitted wireless signal.

The device may include an indication of the received wireless signals in the transmitted wireless signals, so that the transmitted wireless signals can be used to determine a location of the device relative to the interactive surface.

There is provided an interactive display system comprising circuitry for detecting a contact point provided by a pointing input or a touch input at an interactive surface thereof, the system comprising circuitry for receiving data associated with a contact point; circuitry for determining if a wireless signal is received; circuitry for, in dependence on receipt of a wireless signal, identifying said data as touch data or pen data.

There is provided circuitry, including a system, apparatus or device, for providing the feature of any of the above method definitions.

There is provided a device for an interactive display system, the device adapted to provide a contact point at an interactive surface of the system, the device adapted to receive a wireless signal, and transmit a wireless signal responsive to detection of receipt of the wireless signal.

The receipt of the wireless signal may energize the device. The receipt of the wireless signal may comprise detecting a wireless signal which is provided by the system in addition to a wireless signal for detecting a contact point.

The device may receive a plurality of wireless signals. The device may determine an approximate position relative to the display surface on detection of the plurality of wireless signals, and provides an indication of said approximate position in the transmitted wireless signal. The device may include an indication of the received wireless signals in the transmitted wireless signals, so that the transmitted wireless signals can be used to determine a location of the device relative to the interactive surface.

### BRIEF DESCRIPTION OF THE FIGURES

The present invention is now described by way of reference to the accompanying figures, in which:

FIG. 1 illustrates a typical touch detection apparatus;

FIG. 2 illustrates a schematic of a first arrangement of a touch detection apparatus adapted to detect a contact point provided by a pen;

FIG. 3 illustrates a process for controlling the schematic apparatus of FIG. 2;

FIG. 4(a) to FIG. 4(c) illustrates the addition of flag bits to data in accordance with the first arrangement;

FIG. 5 illustrates a schematic of a second arrangement of touch detection apparatus adapted to detect a contact point provided by a pen;

FIG. 6 illustrates a process for controlling the schematic apparatus of FIG. 5;

FIG. 7(a) to FIG. 7(d) illustrates the addition of flag bits to data in accordance with the second arrangement;

FIGS. 8(a) and 8(b) illustrate an exemplary system implementation of an apparatus for the first to second arrangements;

FIG. 9 illustrates an exemplary system implementation illustrating a third arrangement of a touch detection apparatus adapted to detect a contact point provided by a pen;

FIG. 10 illustrates an exemplary implementation of pen circuitry in accordance with this third arrangement;

FIG. 11 illustrates a schematic of the third arrangement of touch detection apparatus adapted to detect a contact point provided by a pen;

FIG. 12 illustrates a process for controlling the schematic apparatus of FIG. 11;

FIG. 13 illustrates a process for controlling the pen apparatus of FIG. 10;

FIG. 14 illustrates a principle of operation of the pen circuitry of FIG. 10;

FIG. 15 illustrates an exemplary implementation of pen circuitry in accordance with a fourth arrangement; and

FIG. 16 illustrates a schematic of the fourth arrangement of touch detection apparatus adapted to detect a contact point provided by a pen.

### DESCRIPTION OF PREFERRED EMBODIMENTS

The invention is described by way of example and with reference to exemplary arrangements, and particularly in relation to exemplary interactive systems. The invention is not limited to any specific detail or arrangement described herein unless explicitly stated or defined by the accompanying claims. One skilled in the art will appreciate how described arrangements may be modified, as appropriate, with alternatives.

In the following description reference is made to a touch input. In practice the term ‘touch input’ is used to refer to any input at an interactive surface of an interactive system provided by any passive input device that allows interaction with programs, buttons and menus. A passive input device may be an input device with no technology housed in it and that cannot communicate with the interactive system other than to provide a contact point. A passive input device may include, but not be limited to, a body part such as a finger, a stylus or a pointer. In this context a passive input device is a device which cannot interact with the interactive system other than by providing a contact point on the interactive surface. A passive device may also be referred to as an inactive device.

In general a touch input can be detected as a contact input, but cannot be uniquely identified and cannot be identified as being on the interactive surface or proximate the interactive surface.

In the following description reference is also made to a pen input. In practice, the term ‘pen input’ is used to refer to any input at an interactive surface of an interactive system provided by any input device that allows interaction with programs, buttons and menus. Such an active input device may be an input device having technology, such as printed circuitry and/or a battery, housed in it, and allowing the device to communicate with the interactive system to provide a more natural interaction with the interactive system. A pen input device can provide additional features such as, but not limited to, detection of the active input device hovering above the interactive surface, pressure sensitive handwriting, and quick tool and functionality access through the inclusion of electrical switch buttons on the active input device, such as on the side of a pen input device. An input device can be any type of device, but typically may be provided by a device which resembles and is referred to as a pen device or pointing device. An input device may include, but not be limited to, light pens, infrared pens, inductive pens and capacitive pens. To the extent that such additional operations require an active link with the interactive system beyond simple detection of a contact point, a pen device can be considered to provide an active input and be an active input device.

In the art, pen devices are sometimes referred to as being passive or active devices in dependence on whether they have internal power sources for providing their interaction with the interactive system or not. For example, an active pen may be provided with a battery. This definition is not to be confused with reference to a touch input or a pen input being associated with a passive/inactive input device or an active input device. An active input device may be ‘passive’ or ‘active’ in terms of a power source. Exemplary arrangements may be advantageously implemented in conjunction with a pen input provided by an active pen in order to provide an appropriate transmission which is detected by an appropriate interface of the interactive system. Arrangements as described may be implemented with the pen being provided by either a passive or an active pen, unless the specifics of an arrangement requires an active pen.

When a pen device providing a pen input is required to provide a pen input it may be equipped with its own power source (active), or it may be adapted to utilise the energy in another signal of the interactive system (passive), such as the energy in an electromagnetic (EM) field, such as an infra-red (IR) or radio frequency (RF) field, provided on an interactive surface for detecting contact points.

Thus an active pen may have an active power source or a passive power source.

Where a pen provides an input in a touch-only system, it may be considered a stylus.

In general a pen input can be detected as a contact input, and can be at least one of: uniquely identified (identifying the pen amongst a plurality of pens); determined as being on the interactive surface or proximate the interactive surface (such as indicating a hover or pen down state); or provide an additional input (such as a switch state).

Arrangements are described herein in the context of touch detection systems, and particularly interactive systems in which an input is detected as a touch input based on a touch provided by that input. The invention is not limited to any specifics of a touch system unless specifically stated herein, and may be implemented in any touch detection interactive system.

When a pen device providing a pen input is adapted to transmit, it may be adapted to transmit continually or only when certain conditions are met, for example when the pen contacts the interactive surface (which for example may be facilitated by a pressure switch in the pen nib).

The invention is not limited to any arrangement of a pen device for providing a pen input although different types of pen device may allow advantageous features of the invention to be implemented.

The description of arrangements refers to detection of a wireless signal in order to detect the presence of a pen device.

The arrangements are applicable to any system in which an indication is to be provided as to whether a contact point is associated with a touch input or a pen input and thus whether a pen device providing pen inputs is present.

The system may be arranged to detect the presence of a pen device only when the pen is in contact with the touch surface, and not for example to detect the presence of a pen distant from the surface, to avoid spurious or mistaken detection. On this basis a pen device may only be detected as present when a ‘pen-down’ condition is detected.

A pen detector may only be enabled when a contact point is detected, or the wireless detection of a signal from a pen device may be arranged such that it can only be detected if the pen is at or near the surface.

The invention is not limited to enabling pen detection circuitry only when a contact point is detected. In an embodiment, pen detection circuitry may continually look for a pen, and may not be enabled only responsive to a contact point.

With respect to detecting the pen device only when the pen is near the surface, the pen may emit or detect an IR signal in a narrow zone, so that a signal from the pen is only received or detectable when the pen is in close proximity to the surface.

This is an alternative or additional feature to enabling a pen detector only when a contact is detected. When the pen is arranged to receive an electromagnetic signal to give it power to transmit, it may be arranged so that it can only receive a signal to provide its necessary power when it is within certain proximity of the display surface. Alternatively or additionally a pen detector may be arranged so that it can only receive a transmission from the pen when the pen is within certain proximity of the display surface.

The receiver/detector forming part of a pen detector of the interactive system may be designed to have a restricted field of view to ensure that detection of the pen device by a wireless pen detect block is only achieved when the pen device is within a short distance, for example centimetres or millimetres, of the surface, to avoid spurious pen detection.

These are all alternative arrangements which allow for the wireless detection not to be solely dependent on first detecting a contact point, or limit the wireless detection to detecting wireless signals only from pen devices which are close to the surface, and not for example a wireless pen which is distant from the surface and not otherwise being detected as present at the surface.

Communication between a pen and a pen detector is preferably via IR transmission, and controls the associated field of view in accordance with preferred arrangements, but communication is not limited to IR transmission, and may for example be an RF transmission such as a Bluetooth transmission. In general it may be preferable to provide a communication channel between the pen device and the interactive system which is a different type of communication than that which is provided for otherwise detecting a contact point.

The communication channel between the pen device and the interactive system may be referred to as a ‘back-channel’, the main channel being the channel provided to detect a contact point.

A first arrangement which provides for detection of a pen device for providing pen inputs in a touch contact detection system is now described. In this first arrangement there is disclosed a technique for determining if a single detected contact is associated with a touch contact or a pen contact.

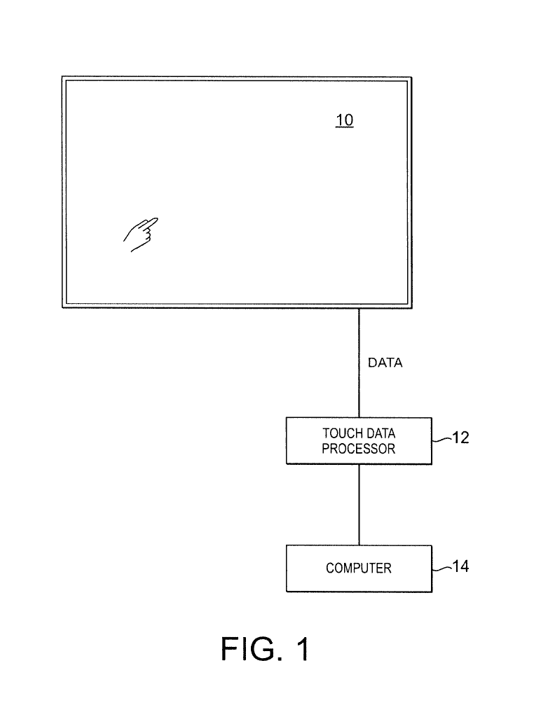

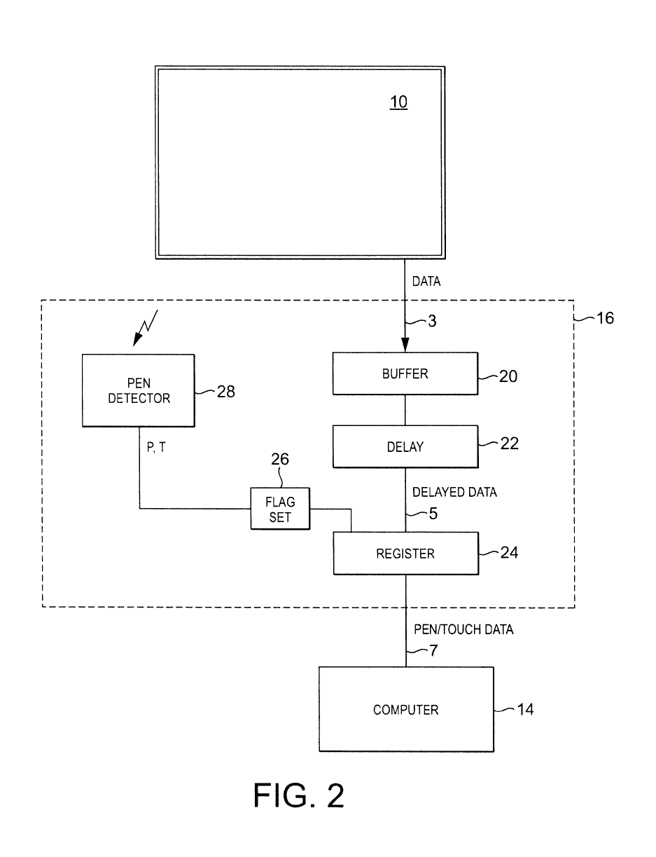

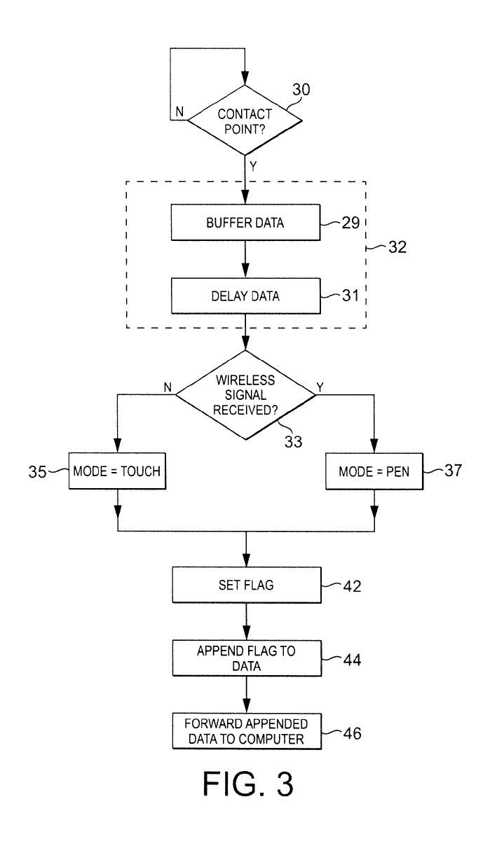

FIG. 2 illustrates schematically the touch contact system of FIG. 1 adapted in accordance with the first arrangement to distinguish between pen inputs and touch inputs, and an associated flow process is illustrated in FIG. 3.

With reference to FIG. 2, there is provided an interface 16 between the interactive surface 10 and the computer 14. The interface 16 comprises a buffer 20, a delay block 22, a register 24, a pen detector 28, and a flag set block 26.

A contact point on the interactive surface is detected, and data associated with this contact point, termed DATA, is forwarded on line 3 from the interactive surface 10 to the interface 16. The detection of this contact point is illustrated by step 30 in FIG. 3.

The contact point may be provided by a touch, for example a finger or a stylus or a pen.

The interface 16 receives the data stream from the interactive surface 10, which in practice may comprise receiving coordinate data from the touch surface when coordinate determination circuitry is provided with the surface. This coordinate data may be received on any electrical connection, for example, via a USB connection, but could also be received via a wireless communication network, such as Bluetooth. In the example it is assumed that the touch surface generally provides data associated with a contact point, which includes the coordinates of that contact point, but this is irrelevant to the present invention.

The data stream DATA is received by the buffer 20, and as denoted by step 29 is buffered. Also illustrated in FIG. 2 is a delay block positioned at the output of the buffer 20, and as denoted by step 31 the buffered data is also delayed. In practice, the buffer 20 may perform the delay function, and so an additional delay block 22 may not be required. The steps 29 and 31 of FIG. 3 may therefore be implemented as a single buffering/delaying step, as illustrated by reference numeral 32.

The delay associated with the buffering and/or delaying steps provided by blocks 20 and 22 results in a delayed version of the data stream DELAYED DATA being produced on line 5.

The pen detector 28 may be enabled by receipt of contact point data, and may be connected to receive the data stream DATA (not shown) simply to identify the presence of data associated with a detected contact point and thus provide a trigger. The pen detector 28 may alternatively be enabled by some control means, such as the computer 14, or may be permanently enabled to detect a wireless signal.

The pen detector 28 is adapted to detect whether a wireless signal is received, as denoted by step 33, following or in tandem with detection of a contact point. A pen providing a contact point is adapted to provide a wireless transmission for detection by the pen detector 28. The pen detector 28 is adapted to detect this wireless transmission.

As is mentioned above, and will be discussed further below, the pen and/or interface 16 are preferably adapted such that a wireless signal from the pen can only be detected/received when the pen is within a certain proximity of the interactive surface.

In dependence on whether a wireless signal is received in combination with detection of a contact point, the pen detector 28 dictates whether the system operates in pen mode or touch mode.

In this first arrangement, if a wireless signal is received the system operates in pen mode as denoted by step 37. If a wireless signal is not received the system operates in touch mode, as denoted by step 35. The pen detector 28 sets a signal on its output to indicate a pen (P) or a touch (T), to control the flag set block 26 to set the flag bits of the register 24 in accordance with the mode of operation.

If the pen detector 28 does not detect a wireless signal, then the pen detector 28 sets its output accordingly to the flag set block 26 indicating that no pen is present. This may simply comprise setting its output to ‘0’ or ‘1’ to indicate the system mode (pen or touch) which is followed by the flag set block 26. The setting at the output of the flag set block indicates a touch mode.

If the pen detector 28 does detect a wireless signal, then the pen detector 28 sets its output accordingly to the flag set block 26 indicating that a pen is present. Again this may simply comprise setting its output to ‘0’ or ‘1’. The setting at the output of the flag set block indicates a pen mode.

On determination of the mode of operation, in step 42 the appropriate flag is set by the flag set block 26. In step 44, the flag set block then controls the register to append the appropriate bits to the current data which is held in the register 24.

As denoted by step 46, the appropriately appended data is then output by the register 24 to the computer 14 on line 7 as the data PEN/TOUCH DATA.

Some latency is associated with the passing of the data to the computer 14, because of the additional processing needed to determine whether the contact is provided by a touch or a pen. Data processing is not performed by the computer 14 until a determination of the input is made, and such processing has a latency determined by the delay of the buffer 20 and/or delay block 22.

The delay provided by the buffer 20 and/or delay block 22 is preferably sufficient to allow the pen detector 28 to complete a determination of whether the contact input is a pen input or a touch input. The data stream may be delayed by n frames, where n=1 or 2 or 3, etc. Preferably the data stream may be delayed by one frame—i.e. frame delayed. During the delay, the pen interface 16 determines whether the object on the surface is a pen. This may be done in a number of ways and the above described technique represents a way of achieving this in accordance with a first arrangement.

The data DELAYED DATA provided to the register 24 is the data for which the mode of operation is determined for the flag setting.

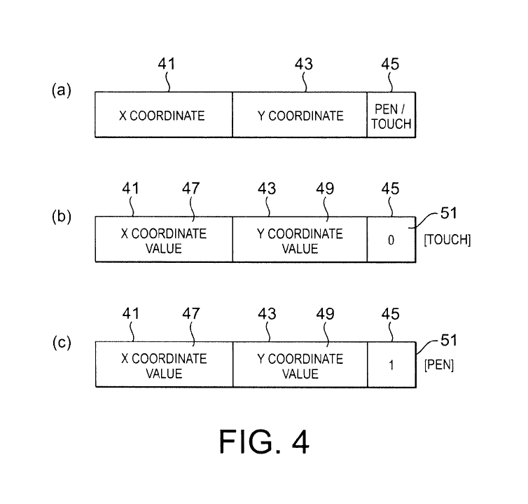

With further reference to FIG. 4, there is illustrated the modification of the received data to append flag bits in accordance with this embodiment.

FIG. 4(a) illustrates in general the format of the PEN/TOUCH DATA provided by the register 24 to the computer 14. The PEN/TOUCH DATA format comprises an X coordinate field 41, a Y coordinate field 43, and a pen/touch field 45. The pen/touch field is set by the flag set block 26 according to whether a pen is detected by the pen detector 28, and may have a value of ‘0’ or ‘1’ to denote one of two states.

FIG. 4(b) illustrates the values set in the event that a contact point is determined to be a touch. In such case, a wireless signal is not detected by the pen detector 28 responsive to detection of a contact point. The flag set block 26 thus controls the flag field 45 to set the value of this field as ‘0’, as denoted by the value 51 in FIG. 4(b). The field 41 has a value 47 and the field 43 has a value 49. This assumes that ‘0’ denotes touch.

FIG. 4(c) illustrates the values set in the event that a contact point is determined to be a pen. In such case, a wireless signal is detected by the pen detector 28 responsive to detection of a contact point. The flag set block 26 thus controls the flag field 45 to set the value of this field as ‘1’, as denoted by the value 53 in FIG. 4(b). The field 41 has a value 47 and the field 43 has a value 49. This assumes that ‘1’ denotes pen.

The pen may be adapted to transmit, and the pen detector receive, at a specific frequency, multiple specific frequencies, or a range of frequencies.

In this arrangement the pen is required to transmit a wireless signal, but no other requirement is imposed on the pen. An active pen may continuously transmit a wireless signal. A passive pen may transmit a wireless signal whenever it is energized. The pen may transmit a wireless signal only when a pressure switch at its nib is activated, responsive to the nib being pressed against the display surface.

In this arrangement, a contact point on the display surface is able to be identified as a contact point provided by a touch or a pen. However the technique does not extend to identification of multiple contact points, since the presence of a pen is provided only. Thus the presence of a pen can only be mapped to the coordinates of a contact position.

The first arrangement provides a technique for determining if an initial contact point is a pen contact or a touch contact. Once this determination is made, all further contact points are assumed to be the same, so the appropriate flag bit is fixed for all further data sets associated with further contact points in further frames. Once contact ceases, and no data is provided, upon detection of a next contact point a determination is again carried out.

In an alternative, the determination could be made for every contact point.

A second arrangement which provides for detection of a pen in a touch contact detection system is now described. In this second arrangement there is disclosed a technique for determining if a single detected contact is associated with a touch or a pen contact in a pen-up or pen-down state.

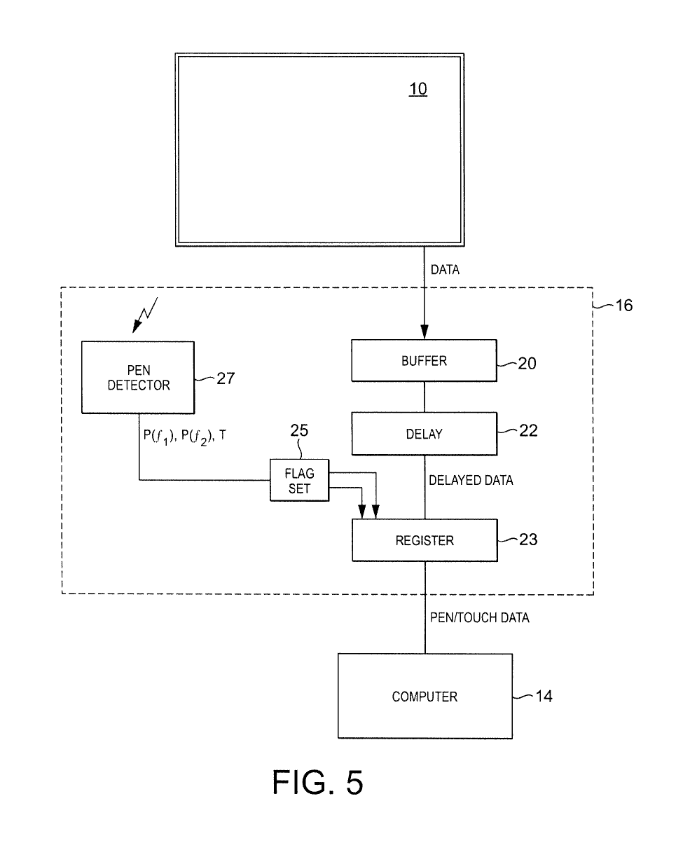

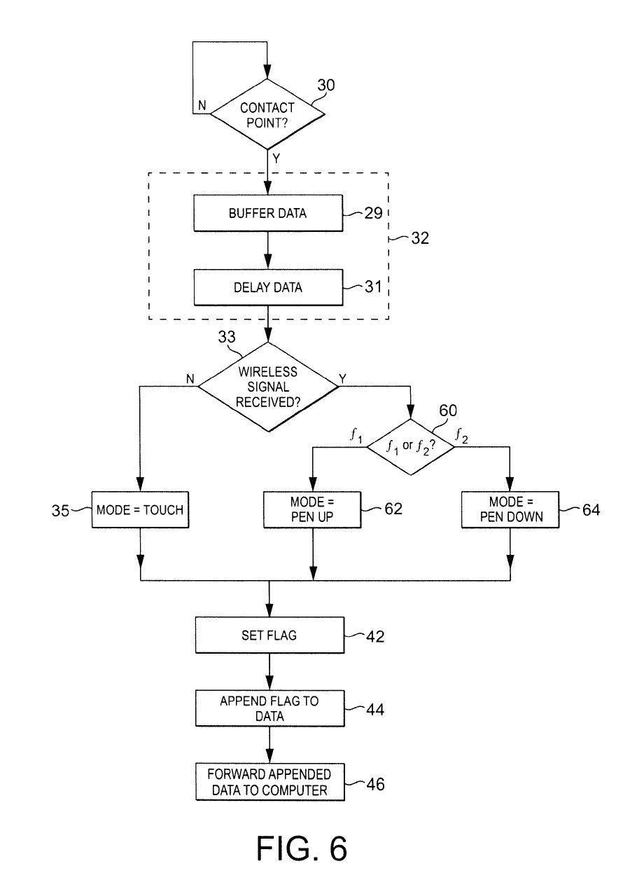

FIG. 5 illustrates schematically the touch contact system of FIG. 2 adapted in accordance with this second arrangement. The process of FIG. 6 is also referenced to illustrate this embodiment and is an adaptation of the process of FIG. 3. Where reference numerals refer to like elements in previous figures, the elements are not further described.

With reference to FIG. 5, there is provided the interface 16 between the interactive surface 10 and the computer 14. The interface 16 comprises the buffer 20 and the delay block 22 performing the same purposes as previously described. In addition the interface 16 includes a modified register 23, a modified pen detector 27, and a modified flag set block 25.

The process in accordance with this second embodiment is similar to that described above with reference to FIG. 3, but as illustrated in FIG. 6 after step 33 in a step 60 it is determined if the detected wireless signal matches either one of two signal frequencies, denoted in this example as f₁ and f₂.

In general terms, in accordance with this embodiment the pen detector is adapted to identify a wireless signal of one of two specific frequencies, which a pen providing a contact point is adapted to transmit. The pointing device is adapted to transmit at the frequency f₁ when a pressure switch provided at the ‘nib’ of the pointing device is not activated, and to transmit at the frequency f₂ when a pressure switch provided at the ‘nib’ of the pointing device is activated. Thus it may be detected, when a pen is present, whether an input condition represents a pen-up or a pen-down condition.

In a simple arrangement, the pen detector may detect just the frequency f₂.

In order to support the detection of a wireless signal at one of two specific frequencies, as denoted in FIG. 5 the pen detector 27 is adapted. The flag set block 25 and the register 23 are further adapted to allow the flag to be set, and the data to have bits appended, in accordance with the modified process of FIG. 6.

As denoted in FIG. 6, the process is adapted such that if a wireless signal is detected in step 33 then in step 60 it is determined whether the frequency of the wireless signal is f₁ or f₂. If it is determined in step 60 that the detected wireless signal has a frequency f₁, then the process moves to step 62 and the mode is determined to be a pen-up mode. If it is determined in step 60 that the detected wireless signal has frequency f₂ then the process moves to step 64 and it is determined that the system is in a pen-down mode.

Thus the system in accordance with this second arrangement can determine between two modes of operation: touch; and pen-up or pen-down.

In this second arrangement, it is assumed that for a pen to be detected as being associated with the contact point a wireless signal of a specific frequency f₁ or f₂ must be detected. In a preferred aspect, the signal will only have frequency f₂ when a switch in the nib of the pointing device which is activated by pressure of the pointing device against the interactive surface is set. Thus, in this embodiment the system is adapted to detect a ‘pen-down’ condition, which simulates a mouse left-click operation. When a touch point is detected, it is assumed also that a touch point is associated with a mouse left-click. This may be advantageous where, for example, a contact point is provided by a device such a stylus.

In the preferred aspect of this arrangement, the flag set block 25 is adapted to set two flags, a first flag associated with whether a contact is associated with a pen or a touch, and a second flag associated with a pen-up or a pen-down condition being determined. In combination, these two flags indicate whether the data associated with a contact point is to be associated with a pen or a touch, and if associated with a pen then identify what aspect of the pen mode is set.

If the pen detector 27 does not detect a wireless signal, then the pen detector 27 sets its output accordingly. The flag set block 25 then sets two flags accordingly. This may comprise setting one flag to ‘0’ or ‘1’ to indicate the touch mode, and further setting another flag to ‘0’ or ‘1’ to indicate the pen down condition or left-click for touch. The setting at the output indicates a touch mode.

If the pen detector 27 does detect a wireless signal, which is the frequency f₁, then the pen detector 27 sets its output accordingly. The flag set block 25 then sets two flags accordingly. This may comprise setting one flag to ‘0’ or ‘1’ to indicate the pen mode and further setting another flag to ‘0’ or ‘1’ to indicate the pen-up condition. The setting at the output indicates a pen mode.

If the pen detector 27 does detect a wireless signal that is at the frequency f₂ then the pen detector 27 sets its output accordingly. The flag set block 25 then sets two flags accordingly. This may comprise setting one flag to ‘0’ or ‘1’ to indicate the pen mode, and further setting another flag to ‘0’ or ‘1’ to indicate the pen-down condition or left-click. The setting at the output indicates a touch mode.

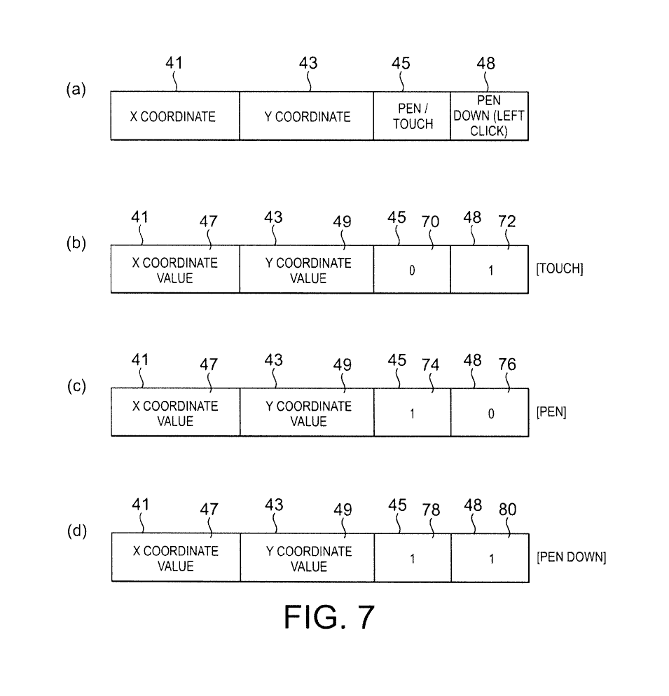

With further reference to FIG. 7 there is illustrated the modification of the received data to append flag bits in accordance with this aspect of the arrangement.

FIG. 7(a) illustrates in general the format of the PEN/TOUCH DATA provided by the register 24 to the computer 14. The PEN/TOUCH DATA format comprises an X coordinate field 41, a Y coordinate field 43, a pen/touch field 45, and a pen down (or left click) field 48. The pen/touch field and the pen down field are set by the flag set block 25 according to whether a pen is detected by the pen detector 27, and each field may have a value of ‘0’ or ‘1’ to denote one of two states.

FIG. 7(b) illustrates the values set in the event that a contact point is determined to be a touch. In such case, a wireless signal is not detected by the pen detector 27 responsive to detection of a contact point. The flag set block 25 thus controls the flag field 45 to set the value of this field as ‘0’, as denoted by the value 70 in FIG. 7(b). The flag set block 25 controls the flag field 48 to set the value of the pen-down field as ‘1’, as denoted by the value 72 in FIG. 7(b). The field 41 has a value 47 and the field 43 has a value 49.

FIG. 7(c) illustrates the values set in the event that a contact point is determined to be a pen with a pen-up condition. In such case, a wireless signal is detected by the pen detector 27 at frequency f₁ responsive to detection of a contact point. The flag set block 25 thus controls the flag field 45 to set the value of this field as ‘0’, as denoted by the value 74 in FIG. 7(c). The flag set block 25 controls the flag field 48 to set the value of the pen-down field as ‘0’, as denoted by the value 76 in FIG. 7(c). The field 41 has a value 47 and the field 43 has a value 49.

FIG. 7(d) illustrates the values set in the event that a contact point is determined to be a pen with a pen-down condition. In such case, a wireless signal is detected by the pen detector 27 responsive to detection of a contact point. The flag set block 25 thus controls the flag field 45 to set the value of this field as ‘1’, as denoted by the value 78 in FIG. 7(d). The flag set block 25 controls the flag field 48 to set the value of the pen-down field as ‘1’, as denoted by the value 80 in FIG. 7(d). The field 41 has a value 47 and the field 43 has a value 49.

In this second arrangement the pen is required to transmit at two wireless frequencies, with a switch provided responsive to pressure of the pen against the interactive surface to switch between the two frequencies. No other requirement is imposed on the pen.

The second arrangement provides a technique for determining if an initial contact point is a pen contact or a touch contact. Once this determination is made, all further contact points are assumed to be the same. However, the determination may be made for every contact point so, for example, it can be detected when a pen changes from a pen-down state to a pen-up state. Preferably, though, a contact point is assumed to be in the same state as the initial determination until that contact point is lost.

Details of the first and second arrangements may be interchanged and combined, and the arrangements are described above with reference to preferred implementations. Individual features of the two arrangements may be advantageously used independently.

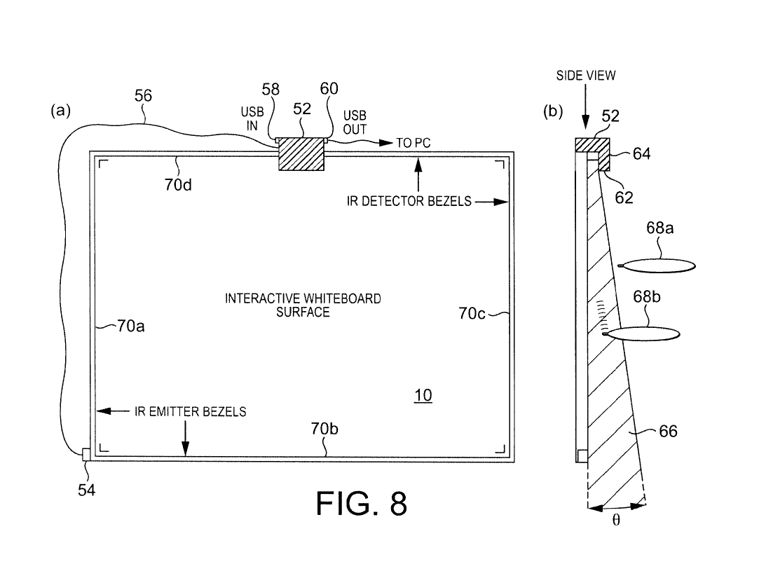

An example apparatus is shown in FIGS. 8(a) and 8(b), in which apparatus of the first or second arrangements described above may be advantageously implemented. FIG. 8(a) illustrates a view onto the display surface, and FIG. 8(b) illustrates a corresponding side view of the arrangement of FIG. 8(a). In the following, reference is made to the first arrangement described above for ease of description.

With reference to FIGS. 8(a) and 8(b), reference numeral 10 generally illustrates the interactive surface of FIG. 2. It is assumed that the interactive surface has touch detection capability.

In an example, the interactive surface is a surface of an interactive whiteboard (IWB) provided with bezel technology for detecting contact inputs, and ordinarily associating such contact inputs with a touch input. Referring to FIG. 8(a), the whiteboard is provided with a vertical IR emitter bezel array 70a, a horizontal IR emitter bezel array 70b, a vertical IR detector bezel array 70c, and a horizontal IR detector bezel array 70d. The implementation of bezel technology to allow detection of a contact point on an interactive surface is well-known in the art and is not shown in detail in FIG. 8(a).

As also illustrated in FIG. 8(a), the system is provided with a USB port 54 for a touch detection system (not shown), although in a further embodiment this connection could be provided by other wired or wireless technology, such as Bluetooth. The implementation of a touch detection system to allow for detection of a contact point on a bezel system will be well-known to one skilled in the art.

The illustrated use of a bezel system and bezel technology is merely exemplary.

In accordance with the illustrated exemplary arrangement, the system is additionally provided with a pen augmentation interface 52, which has a USB input port 58 which is connected by a cable 56 to the USB port 54 of the touch system. The pen augmentation interface 52 additionally is provided with a USB port 60 for connection to a computer. The pen augmentation interface 52 provides the additional electronic circuitry needed to provide for detection of pen and touch in accordance with the foregoing described exemplary arrangements, and is connected to the existing board and touch detection circuitry.

Comparing FIG. 2 to FIG. 8(a), the wire 56 between USB ports 54 and 58 correspond to connection 3, and the wire from USB port 60 corresponds to connection 7. The interface 16 is implemented within the pen augmentation interface 52.

Although in FIG. 8(a) a wired connection is illustrated between USB port 54 and USB port 58, this is merely exemplary and the ports may be wireless ports providing a wireless connection. Similarly port 60 may be a wireless port.

The pen augmentation interface 52 is preferably provided with an IR transceiver to provide for communication with a pen device, to implement the operation of the pen detector, such as pen detector 28.

With reference to FIG. 8(a) and FIG. 8(b), the pen augmentation interface is preferably mounted with respect to the interactive display surface to allow an IR transceiver 62 to illuminate with IR the interactive display surface 10.

An IR illumination field 66 produced by the IR transceiver 62 is additional to and separate from the IR transmission/reception associated with the bezel technology. This IR illumination field 66 is provided to allow, in accordance with this described embodiment, detection of a pen device.

The location of the pen augmentation interface 52 may be chosen to allow the IR illumination field 66 to be optimised for the interactive surface. In the described example, the interface 52 including the IR transmitters is located at the centre of the top edge of the interactive whiteboard, although a person skilled in the art will recognise that the interface including the IR transmitters could be located in other positions.

The field of view of the IR transceiver 62 across the interactive surface is preferably limited to a region proximate to the surface, so that a region spaced from the surface is not illuminated by the IR transceiver. This may be achieved by the design or orientation of the IR transceiver, which is outside the scope of the present invention, or by the provision of a plate or housing 64 (as shown in FIG. 8(b)) in front of the IR transceiver 62 which limits its optical field.

As illustrated in the example of FIG. 8(b), the IR transceiver 62 provides a collimated IR illumination field 66, having a restricted field of view angle. The collimated IR illumination field 66, will typically extend at least lcm from the IWB surface and ideally less than 10 cm from the IWB surface, across the entire surface. The angle of the field of view and the distance the IR field extends from the display surface at any point will be implementation dependent. In the example shown, the illumination field is projected at an angle θ from the projection point. The restriction of the IR illumination field in this way supports an exemplary implementation of the foregoing arrangements.

As denoted by reference numerals 68a and 68b, with a pen 68a outside the IR illumination field 66, a touch mode of operation is determined, as the pen is not detected. With a pen 68b inside the IR illumination field, a pen mode of operation is determined as the pen is detected.

This assumes the pens are adapted to be enabled or activated by the energy of the IR illumination field 66, so a pen is unable to transmit unless it is located within the IR illumination field 66.

When a wireless connection is established between a pen and the pen detector 28 or 27 of the pen augmentation interface 52—a pen-to-interface connection—the system switches to pen-mode. When the pen moves away from the surface, the IR connection is broken and the system reverts back to touch mode.

In embodiments, the presence of the pen may only be detected if, in addition to being in the illumination field 66, the pen is depressed on the display surface, closing a switch provided at the nib.

This arrangement is not limited to any specific configuration of the pen. The pen may be an active pen which constantly transmits a wireless signal. However, the pen preferably may transmit a wireless signal only when it is energized to do so by reception of IR energy which is received within the IR illumination field. The pen may more preferably transmit a wireless signal only when it is energized to do so by reception of IR energy within the IR illumination field, and further only then at some certain time interval, for example by pulse transmissions, or in reply to a request from a pen detect block, which transmits a request when data is received to indicate a contact point has been detected.

The pen may more preferably be adapted to transmit only in response to a request, and the pen may be adapted only to detect a request when the pen is located within the IR illumination field. Thus the pen may start transmitting as soon as it is energized by the IR illumination field 66, or only start transmitting when it is energized by the IR illumination field 66 and receives an interrogation signal from the interface 16.

For power efficiency, the pen may detect a diffused or coherent IR illumination field 66 near to the surface provided by the IR transceiver 62 of the pen augmentation interface 52, and then signal its presence to the pen detector 28 or 27 using the energy provided by the IR illumination field 66. The pen may do so asynchronously, or the pen may wait for a synchronisation beacon emitted from the interface 16 of the pen augmentation interface 52 before transmitting (i.e. respond to an interrogation signal). In such an arrangement the pen preferably only wirelessly signals its presence to the interface 16 when interface 16 has determined detection of a contact at the surface, rather than the pen continually signalling its presence.

The IR connection between the pen and the pen detector 28 or 27 may also act as a communication channel for flagging the state of a switch provided on the tip or side switch of the pen. The pen may simply transmit a code to the pen detect block which identifies the tip or switch state. Such additional information can be included in extended bits added, for example, to the data shown in FIG. 4 or FIG. 7. This additional information can be ‘piggybacked’ onto the signal transmitted by the pen and received by the wireless detector in the interface 16. This additional pen state information may be provided in any of the arrangements.

The IR connection between the pen and the pen detector 28 or 27 may also act as a pen identification for systems with more than one pen, without such information the system being able to detect the presence of a pen but not identify the pen (or identify the pen amongst multiple pens). The pen may simply transmit a code to the pen detect block which identifies the pen. This additional pen identity information may be provided in any of the arrangements.

In examples the pen identity is associated with a transmission frequency, and thus multiple pens can be identified in a system which allows discrimination detection between signals of different frequencies, such as the second arrangement described above.

It may be necessary to use a different wavelength of IR for the communication between the pen and the interface 52 (where IR is used for this communication), to avoid interfering with the touch sensing system of the IR bezel technology. The implementation of the back channel IR, including the relevant frequency of the IR, is an implementation detail. As mentioned above, the back-channel may alternatively be implemented in RF.

Adaptations will provide for advantageous or preferable techniques for establishing the wireless connection between the pen and the pen detect block.

In accordance with the arrangements as described above, there is thus provided the ability to distinguish between a touch and a pen providing a contact point is provided. However this technique as described does not provide for identifying multiple contact points as being associated with one of multiple pens unless the identity of a pen is represented by its signal frequency.

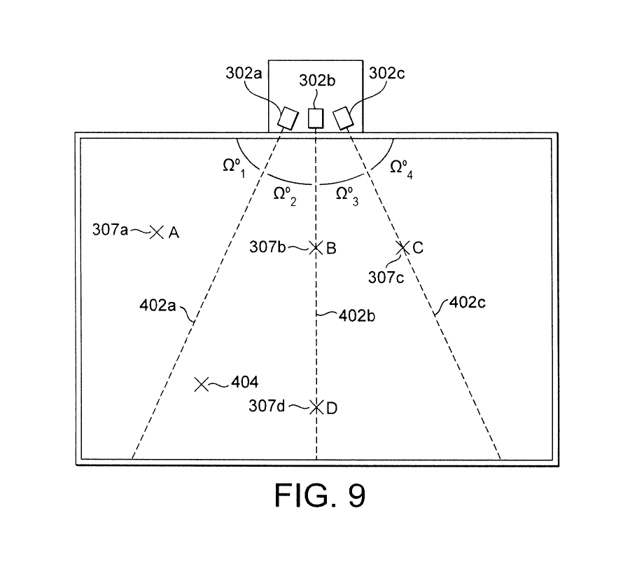

With reference to FIG. 9, a further arrangement is illustrated in which a plurality of co-located IR transceivers (three in the example illustrated, namely 302a, 302b, 302c) are placed in the centre of either an upper or lower horizontal edge of an interactive whiteboard (IWB).

The three transceivers 302a, 302b, 302c each have a respective emitter/transmitter and a respective detector associated therewith.

The emitters of the transceivers are angled such that they direct radiation across the surface so that a photodiode detector located within a tracked pen placed on the surface will receive maximum incident IR flux at different bearings from the three emitters. Thus with each emitter of the three transceivers emitting IR signals, a photodetector of a pen placed on the surface will receive an IR signal from up to three emitters.

Reference numeral 404 denotes an exemplary position on the surface at which a contact point may be provided by a pen.

In the example shown, using a line parallel to the top horizontal edge of the IWB as a ‘0°’ reference, the peak IR signal from the first emitter 302a will lie along a line at Ω₁° from the top horizontal edge of the IWB denoted by reference numeral 402a. The peak IR signal from the second emitter 302b will lie along a line at an angle of Ω₂° from the reference 402a (straight down), denoted by reference numeral 402b. The peak IR signal from the third emitter 302c will lie along a line at Ω₃° from the peak IR signal of the second emitter (denoted by reference number 402b) denoted by reference numeral 402c. The line 402c is additionally at an angle Ω₄° from the reference provided by the top edge of the IWB.

In this embodiment, angles Ω₁°, Ω₂°, Ω₃° and Ω₄° range between 0° and 60°, and are more preferably 60°, 30°, 30° and 60° respectively. The beam width of the transmitters means that the transmitted signals from the three emitters will overlap ensuring there are no areas on the surface that do not receive a minimum level of IR signal required for the system to work.

In accordance with the described embodiment, the three emitters of the transceivers 302a, 302b, 302c may be modulated by three different excitation frequencies, f₁, f₂ and f₃. The emitters of the transceivers are preferably controlled to transmit for a short duration when instructed to do so by a controller associated with a pen interrogator. The purpose of the pen interrogator is to determine whether a pen is close to the surface. The emitters provide a collimated zone of IR across the surface, such as the zone 66 of FIG. 8, requiring pens to be within this zone to be able to detect an interrogation signal.

In accordance with this arrangement a pen is adapted to preferably include a photodiode detector, or more preferably a plurality of photodiode detectors (to ensure predominantly consistent reception of the incident IR field regardless of varying pen orientation) for detecting the IR transmissions from the emitter of one or more of the transceivers 302a, 302b, 302c. The pen is further adapted to include circuitry to process the received signal as discussed below.

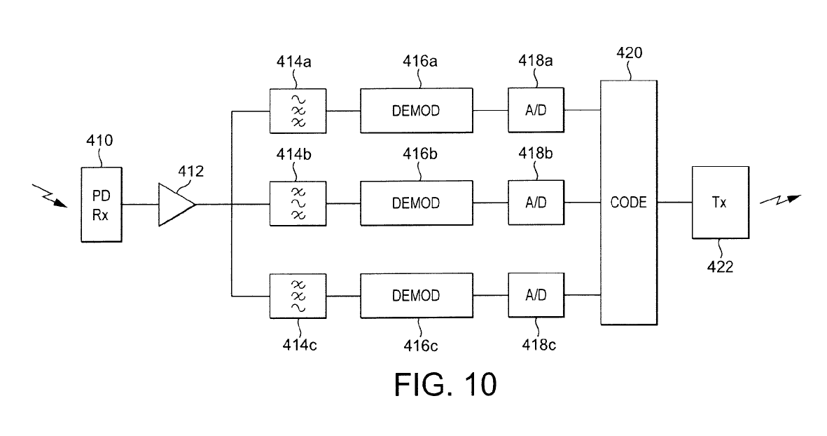

An example implementation of circuitry within a pen in accordance with this arrangement is shown in FIG. 10. The pen includes a photodetector 410, an amplifier 412, multiple filters 414a to 414c, multiple demodulators 416a to 416c, multiple analogue-to-digital converters 418a to 418c, a coder 420, and a transmitter 422.

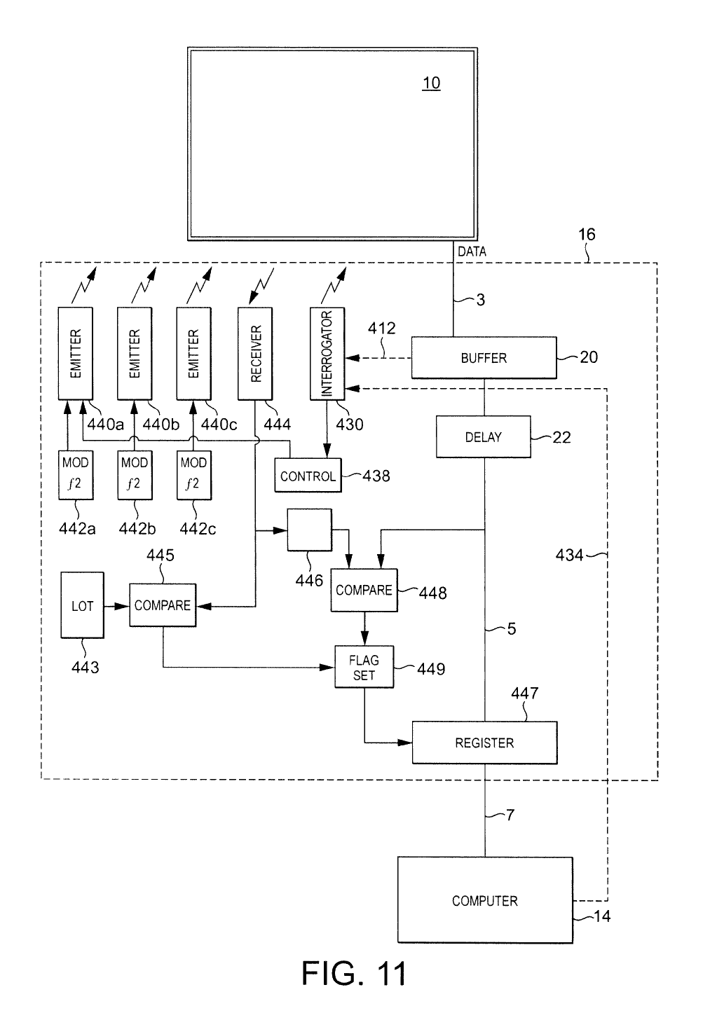

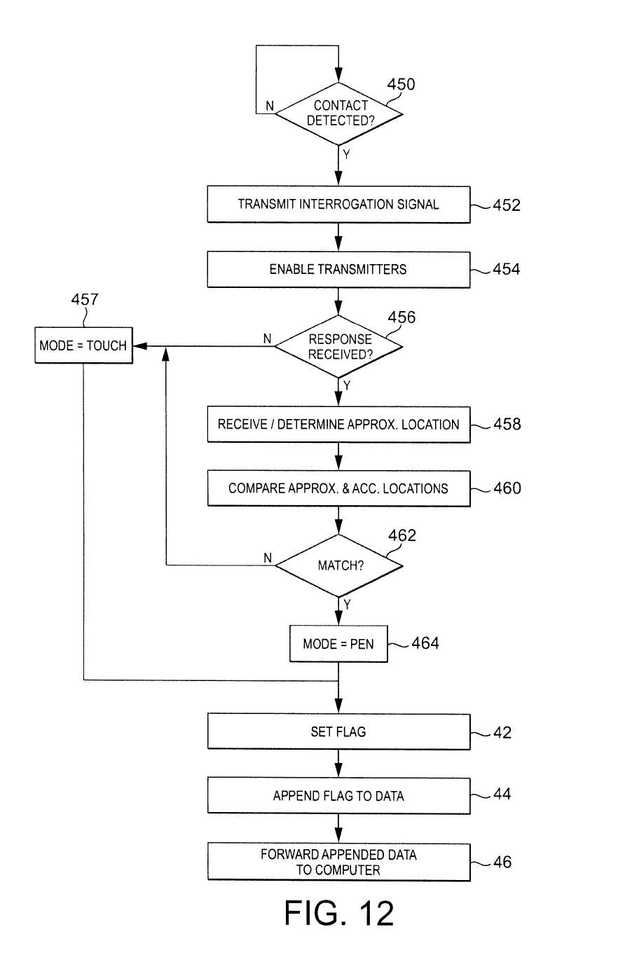

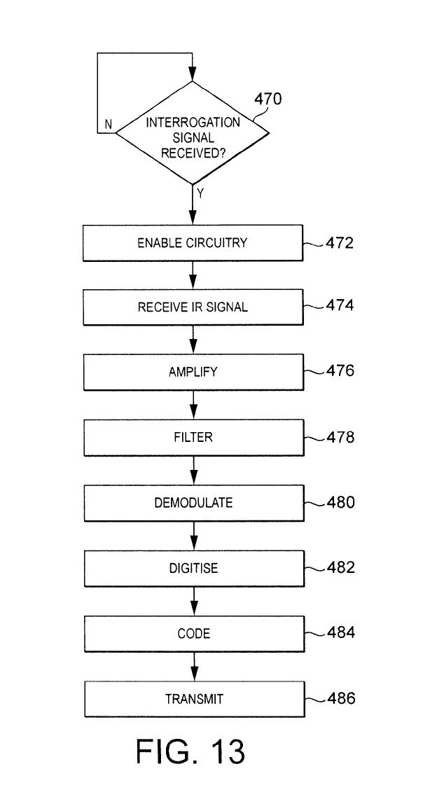

An adaptation of the interface 16 of FIG. 2 or FIG. 5 in accordance with this arrangement is illustrated in FIG. 11. FIG. 12 and FIG. 13 illustrate the methods performed in the pen of FIG. 10 and the interface of FIG. 11 in accordance with this example. The example is now further explained with reference to FIG. 10 to FIG. 13.

The interface 16 includes emitters 440a, 440b, 440c; modulators 442a, 442b, 442c; an interrogator 430; a receiver 444; a control block 438; a position determination block 446; a comparator 448; a flag set block 449; a register 447; a comparator 445; a look-up table 443; the buffer 20; and the delay block 22.

The interrogator 430 is adapted to transmit an interrogation signal. The interrogator may be triggered, for example in response to a signal from the buffer 20 as denoted by dashed line 432 or in response to a signal from the computer 14 as denoted by dashed line 434. The interrogator may be triggered when a contact is detected.

The interrogator is adapted to transmit a signal to ‘wake-up’ a pen. In the event that a pen is present, the pen is ‘woken up’ by the interrogation signal.

In general, as denoted in step 450, a contact is detected, and an interrogation signal is transmitted in step 452.

As denoted by step 470 of FIG. 13, responsive to detection of the interrogation signal a pen ‘wakes up’ and in a step 472 enables its circuitry.

The interrogator block 430 additionally provides a control signal on line 436 to an emitter controller 438. Responsive to the control signal on line 436, which indicates that the interrogator block 430 has transmitted the interrogation signal, the control block 438 selectively enables the emitters 440a, 440b, 440c as denoted by step 454.

Each of the emitters 440a, 440b, 440c is associated with a respective modulation signal at a frequency f₁, f₂, f₃ provided by modulators 442a, 442b, 442c. Thus each emitter emits a signal with a respective modulation.

When a ‘woken up’ pen is within a detection zone, the photodiode detector 410 within the pen detects an incident IR signal from one or more of the plurality of emitters of transceivers 302a, 302b, 302c as denoted by step 474. The signal will be a composite of the multiple modulation frequencies associated with the different emitters.

After amplification in an amplifier 412 as denoted by step 476, the composite signal passes into separate band pass filters 412a, 412b, 412c (equal to the number of emitters) for filtering as denoted by steps 478. The pen circuitry includes a channel for each emitter. They are then demodulated by respective demodulators 414a, 414b, 414c in step 480 to provide a DC voltage proportional to the incident IR signal from each of the plurality of emitters.

The analogue to digital (A-D) converter in each channel, 418a, 418b, 418c, typically within a microprocessor, then measures the plurality of DC voltages and digitises the signals, as denoted by step 482. This information is then output to the coding block 420 and used by the coding block 420 to code a backchannel transmission as denoted by step 484.

The output of the coding block is providing to a transmitter 422 for transmission in step 486.

The transmission from the pen may use an IR emitter in the pen as the transmitter 422, transmitting coded information to an IR detector, preferably co-located with the interrogator controller. The pen transmitter 422 may typically be instructed by a pen microcontroller to transmit after the pen has successfully received an interrogation signal. Alternatively, the backchannel could use an RF link, for example ‘Bluetooth Low Energy’ to relay the pen data packet, with the transmitter 422 being suitably adapted.

Regardless of the backchannel physical layer, the pen data packet will typically consist of a pen identifier data, amplitude data for the received IR interrogator signal, and data to indicate the status of pen flag buttons (tip switch and barrel switch).

The receive block 444 of the interface 16 receives the wireless signal transmitted by the pen. This wireless signal is provided to a unit 446 which determines an approximate or coarse location of the pen based on the received signal. Alternatively the received signal may include the approximate location.

The amplitude of the signal received is different in each detector (416a, 416b, 416c) for different pen bearings, and different pen distances from the detectors. The three vectors of the signals received in the respective detectors allow a coarse bearing to be calculated to approximately locate the position of the pen on the surface generating the wireless signal.

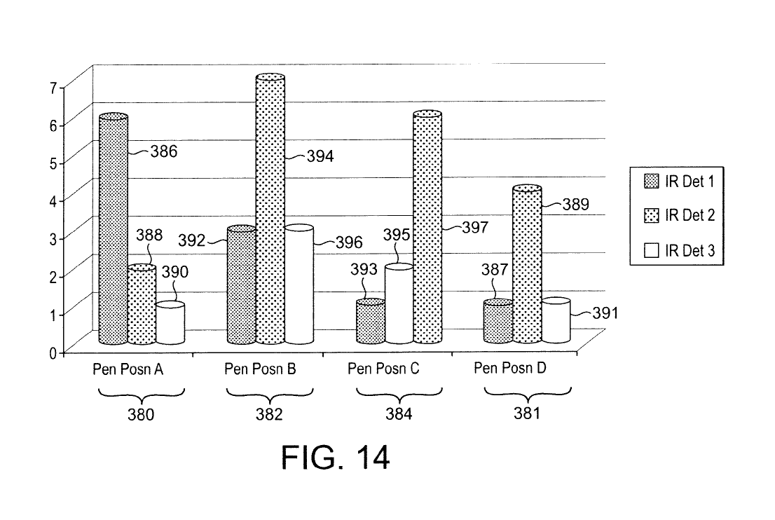

With reference to FIG. 14, this is further illustrated. FIG. 14 illustrates diagrammatically the amplitude of the signals received in a pen by each of the detectors 416a, 416b, 416c, from which it can be determined an approximate location of the pen. In general the signal received in each detector can be used to provide a coarse approximation of location.

A principle of operation in accordance with an example arrangement is now further described. It is assumed that a pen may be positioned on the interactive surface providing contact points at locations 307a, 307b, 307c, and 307d respectively.

Reference numeral 380 of FIG. 14 illustrates the amplitude of the signals received by the IR detectors with the pen in position 307a. The decoder 416a receives a signal having an amplitude as denoted by reference numeral 386, the decoder 416b receives a signal having an amplitude as denoted by reference numeral 388, and the decoder 416c receives a signal having an amplitude as denoted by reference numeral 390.

Reference numeral 382 of FIG. 14 illustrates the amplitude of the signal received by the detectors of a pen in position 307b. The decoder 416a receives a signal having an amplitude as denoted by reference numeral 392, the transceiver 416b receives a signal having an amplitude as denoted by reference numeral 394, and the decoder 416c receives a signal having an amplitude as denoted by reference numeral 396.

Reference numeral 384 of FIG. 14 illustrates the amplitude of the signals received by the detectors of a pen in position 307c. The decoder 416a receives a signal having an amplitude as denoted by reference numeral 393, the decoder 416b receives a signal having an amplitude as denoted by reference numeral 395, and the decoder 416c receives a signal having an amplitude as denoted by reference numeral 397.

Reference numeral 381 of FIG. 14 illustrates the amplitude of the signals received by the detectors of a pen in position 307d. The decoder 416a receives a signal having an amplitude as denoted by reference numeral 387, the decoder 416b receives a signal having an amplitude as denoted by reference numeral 389, and the decoder 416c receives a signal having an amplitude as denoted by reference numeral 391.

Thus there is described above a technique for the pen to coarsely calculate its location.

In a step 456 the interface 16 determines if a response is received in the receiver 444 responsive to the transmitted signals from the emitters 410a, 410b, 410c.

If no wireless signal is received, then the system is determined to be in touch mode as indicated by step 457.

If a wireless signal is received, then as denoted by step 458 a determination is made by the block 446 as to the approximate location of the pen, or the approximate location determined by the pen (for example using the technique of FIG. 14) is retrieved.

In step 460 this coarse location is compared with an accurate location of the contact in block 448.

If, as denoted by step 462, it is determined that the two locations do not match, then the mode is set as touch mode in step 457.

If in step 462 it is determined that the two locations do match, then in step 464 the mode is set as pen mode. In view of the approximate or coarse nature of one of these values, the match may be successful if the positions are within a certain distance of each other.

After the mode is set in steps 457 or 464, the process may proceed to steps 42, 44, 46 as before.

The position determination block 446 provided in the interface 16 receives the coarse location of the pen, or may use the received amplitude data representing the strength of the signal incident at the pen to calculate a coarse bearing for the pen. This may be used to remove ambiguity when a number of devices (pen or touch) are presented simultaneously to the IWB surface and within the interrogator detection zone as described above.

Once a pen is being accurately tracked by the touch system, a more accurate bearing can be calculated and this can be compared with the coarse bearing provided by the IR interrogator system. A calibration correction table can be built up, as the pen is moved over the surface, and stored in non-volatile memory. With prolonged use the accuracy of the coarse location system steadily improves as the system ‘learns’ from the accurate touch coordinate bearing calculation.

The technique described above relates to determination of whether an initial contact point is a pen or a touch, and relating a pen input to a contact by location. As referred to in the preceding paragraph, once a contact is determined as a pen input, it can be tracked without having to compare its location. The values provided from the receiver 444 are compared directly in comparator 445 with values of existing contact points stored in a look-up table (LUT), to identify the pen with which the contact is associated. A value can be associated with a particular tracked contact based on its approximation to the values in the LUT.

A further arrangement is now described, which is a modification of the foregoing arrangement.

In this arrangement, instead of the multiple frequency drive to modulate the plurality of interrogator emitters, the emitters are excited with one frequency and then sequenced in time. The pen may then sample at three different time intervals denoted t1, t2, t3 to obtain three DC levels proportional to the incident energy for the three different sources.

In this arrangement a plurality of co-located IR transceivers are again utilised in accordance with the arrangement of FIG. 9.

As discussed above, an interrogation signal may be transmitted to ‘wake up’ a pen. However the transmitted signals from the transceivers may also be used as a ‘wake up’ signal.

In this arrangement, the emitters do not transmit in tandem, but instead transmit in turn in accordance with their time offsets.

To ensure the pen sees the maximum energy to wake it up, the interface 16 may first ‘fire’ the emitter which is closest to the detected position provided by the coordinates which information may be provided by the interface signal on line 3 or line 5, followed by the other emitters after a predetermined time associated with their offsets.

The pen on waking, samples for time t1, waits a predetermined time, samples for t2, etc. The sampling process is used to determine the amplitude of the incident signal arriving during the period t1, t2 and t3.

This simplifies the pen/low power requirements, as it only requires one band pass filter channel.

The t1 to t3 duration is dependent upon the frequency, and may be in the order of milliseconds.

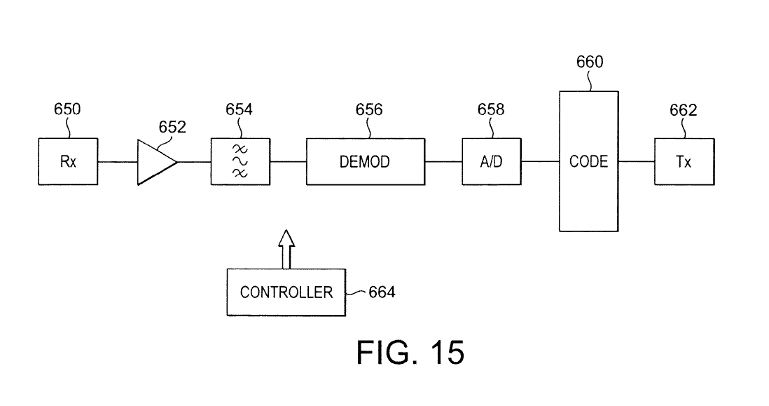

An adaptation of the pen in accordance with this arrangement is illustrated in FIG. 15. The pen includes a receiver 650, an amplifier 652, a bandpass filter 654, a demodulator 656, an analogue-to-digital converter 658, a coder or coding unit 660, and a transmitter 662. It will be apparent that the functional blocks of the pen as illustrated in FIG. 15 are consistent with the functional blocks of the pen as illustrated in FIG. 10 above, except in this embodiment there is no requirement to provide multiple channels. A controller denoted by reference numeral 664 within the pen controls the decoding circuitry to decode the received signals for each of the time offsets. The controller 664 may be adapted to process the received signals in accordance with time offsets for a known time offset, based on an initial timing mark provided by the first signal from the first emitter.

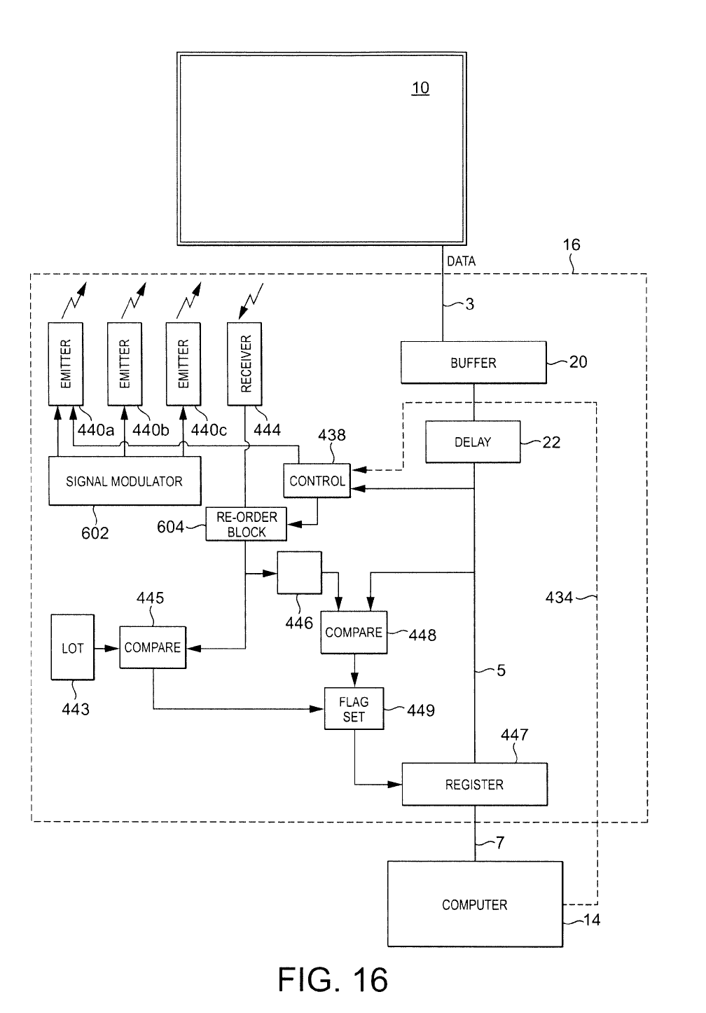

With reference to FIG. 16 there is illustrated an adaptation to the interface 16 in order to implement this arrangement. This adaptation is shown as an adaptation of the interface 16 of FIG. 11.

As shown in FIG. 16 the frequency modulation blocks 442a, 442b, 442c of FIG. 11 are replaced by a single frequency modulation block 602 which provides a signal to each of the three emitters 440a, 440b, 440c. Each of the emitters 440a, 440b, 440c apply a different timing to the signal produced by the signal modulator, but generates signals with the same modulation.

In the arrangement shown in FIG. 16 there is not shown an explicit block for generating an interrogation signal, and in this arrangement it is assumed that the interrogation is provided by controlling one of the emitters 440a, 440b, 440c. In accordance with this exemplary arrangement, the control block 438 is adapted to receive the output of the buffer 20/delay 22, representing the data of the contact point detected. As discussed hereinabove, that data will include coordinate information representing the precise location of the contact detected. The control block 438 utilises this coordination information to enable the one of the emitter blocks 440a, 440b, 440c which is determined to be closest to the specific location, the enablement of that emitter block and the generation of its transmit signal acting as a ‘wake up’ or interrogation signal for the pen. As noted above, the choice as the first emitter being the emitter closest to the detected contact point maximises the likelihood of the transmitted signal waking up the pen.

As denoted hereinabove, it is unimportant which of the emitters 440a, 440b, 440c is first enabled, or the sequence of enablement of the emitters. This is because the control block 438 additionally provides a control signal to a reordering block 604, which has knowledge of which emitter a received wireless signal is received from, such that on receipt of all of the wireless signals the reordering block 604 can reorder the receive signals to be associated, if necessary, with the respective time offsets in sequence.

Other than as described, the circuitry of FIG. 16 operates in accordance with the circuitry of FIG. 11. The control block 438 additionally receives the signal on line 434 from the computer 14.

It will also be understood that the circuitry of FIG. 15 and FIG. 16 operates generally in accordance with the method processes of FIGS. 12 and 13. These Figures are modified as appropriate, with the arrangement of FIG. 16 in particular not requiring the transmission of a dedicated interrogation signal, and requiring the transmission of the signals from the emitters 440a, 440b, 440c to be associated with timing controls provided by the control block 438.

There has been set out above various exemplary arrangements for implementation of techniques for detecting whether a contact point provided in a touch contact system is provided by a pen. Various aspects of each described arrangement may be implemented in other described arrangements. Therefore aspects of each described arrangement may be mixed.

It will be understood from the foregoing description that in exemplary implementations there is a requirement to carry out an initial determination when a contact point is first detected, and thereafter to track that contact point (including the movement of that contact point) until it is no longer provided. The technique for determining the initial contact point, and the technique for monitoring a determined contact point, may be different. The arrangements describe techniques in which contact points provided by multiple different pens may be detected and tracked, without having to determine a frequency of operation associated with a particular pen.

In preferred implementations, an interface (comprising a receiver block) is positioned in the centre top of an interactive whiteboard.

A communications backchannel (IR or RF) may provide pen button flag data and pen unique identifiers. Preferably, however, an IR location signal may be modulated to provide this backchannel functionality.

The above described arrangements illustrate example arrangements of the invention, and embodiments of the invention. Details of the arrangements as described in relation to any particular exemplary arrangement may be combined with details of another exemplary arrangement.

In all arrangements, the system may follow an exemplary logic process, in which the system is placed in touch mode or pen mode in dependence on the determination of the type of the first contact detected.

In the event that no data is received from the interactive surface, the interface 16 may be in a standby mode of operation, and not operational.

When an object is detected, a data stream may be generated by the interactive surface to the interface 16, and the interface 16 leaves the standby mode. The interface 16 may activate an interrogator (where the interrogator is provided) to look for a pen.

If no pen is detected, the data is assumed to be associated with a touch, and the system is locked into touch mode until the tracking of the object is lost. If a pen is introduced to the surface while in touch mode, the contact provided by the pen is treated as a touch input. This may prove useful for dual-handed size gestures without the user having to swap from pen to finger in their pen holding hand.

If a finger track is lost, or where multiple finger contacts are detected the last finger track is lost, then the data stream from the interactive surface halts, and the interface 16 returns to standby mode.

If a pen enters the detection zone, for example the IR bezel detection zone, then a data stream is received by the interface 16 and the interrogator (where provided) is enabled. Where an interrogator is enabled, the pen responds to the interrogation signal, which response may include a pen identifier, and flag status indicating a button status of the pen. Once a response is received, the interrogator can be disabled. The system then enters pen mode. When a button changes state, the state information is passed through to the computer.

Additional finger contacts may occur while in pen mode, and in an embodiment are determined as an invalid contact points for pen mode, and ignored until/unless the system leaves pen mode and enters touch mode.

In the example given it is assumed that the system operates in either pen mode or touch mode, but in variations the system may operate in both pen and touch mode.

When in pen mode, the pen must be moved to beyond the field of the interrogator before the system can exit pen mode and revert to touch mode.

The present invention has been described by way of reference to particular examples and preferable aspects of those examples. One skilled in the art will appreciate that the invention and those examples are not limited to any details given, unless as defined by the appended claims. Various details may be optionally applied in different examples, and various details may be applied alone or in combination to different examples.

1. A method for detecting the presence of a pointing device at an interactive surface, which interactive surface is arranged to detect a contact point, the method comprising: receiving data representing a contact point; determining if a wireless signal is received; and in dependence on receipt of a wireless signal identifying said data as touch data or pen data, wherein a pen is activated to transmit a wireless signal when it is located within certain proximity of the interactive surface.

2. The method of claim 1 wherein the pen transmits a wireless signal responsive to an interrogation signal.

3. The method of claim 1 or claim 2 wherein an interactive system associated with the interactive surface transmits an infra-red illumination field on the interactive surface, additional to any infra-red signal associated with detection of a contact point, for enabling detection of any pen providing the contact point.

4. The method of claim 3 wherein the pen detects an infra-red signal associated with said infra-red illumination field.

5. The method of claim 3 or claim 4 wherein the pen is energized by an infra-red signal associated with said infra-red illumination field.

6. The method of any one of claims 3 to 5 wherein the pen transmits a wireless signal upon detection or receipt of said infra-red signal.

7. The method of any preceding claim wherein the interactive surface detects a contact point provided by touch inputs.

8. The method of any preceding claim wherein if a wireless signal is received the data is identified as pen data.

9. The method of any preceding claim wherein if a wireless signal is not received the data is identified as touch data.

10. The method of claim 8 or claim 9 wherein on identification, the data is transmitted for further processing.

11. The method of any one of any preceding claim wherein transmission of said data for further processing of the data is delayed whilst determination is made as to whether a wireless signal is received.

12. The method of any one of any preceding claim wherein identifying the data as touch data or pen data comprises setting one or more flag bits associated with said data.

13. The method of claim 12 wherein the one or more flag bits may be a single bit, the state of which indicates touch data or pen data.

14. The method of any preceding claim for identifying data associated with multiple contact points as being provided by touch inputs or device inputs, the method further comprising determining a location of any device, and comparing the location of such device to the location of a contact point.

15. The method of any one of claims 1 to 14 in which an interface is adapted to transmit wireless infra-red signals in a plurality of infra-red transmitters, the signals from the respective infra-red transmitters illuminating the interactive surface with an infra-red illumination field.

16. The method of claim 15 in which the central axis of each infra-red transmitter is offset from the central axis of each other infra-red transmitter.

17. The method of claim 15 or claim 16 in which a pen positioned on the interactive surface receives a signal from one or more of the infra-red transmitters, and processes the received signals.

18. The method of claim 17 in which the pen transmits a signal to the interface, which signal is indicative of a coarse location of the pen.

19. The method of claim 18 in which the signal transmitted from the pen is an indication of the amplitude of the signal received from each transmitter.

20. The method of any one of claims 1 to 19 in which the signal transmitted is modulated by each transmitter with a different frequency.

21. The method of claim 20 in which the time offset of each signal is the same.

22. The method of claim 20 or claim 21 in which the pen detects a composite signal being the signal detected at at least one transmitter.

23. The method of claim 22 in which the pen processes the composite signal to provide one or more signals indicating the coarse position of the pen.

24. The method of claim 23 in which the one or more signals are one or more amplitude signals representing the amplitude of the signals received at the pen from each transmitter.

25. The method of claim 24 in which the pen determines a coarse location of the pen based on said signals, and transmit said coarse location to the interface.

26. The method of claim 24 or claim 25 in which the pen transmits the one or more amplitude signals representing the amplitude of the signals received at the pen from each transmitter to the interface.

27. The method of claim 26 in which the interface determines a coarse location for the pen in dependence thereon, and compare said coarse location to an accurate location.

28. The method of claim 26 in which the interface compares the one or more amplitude signals to one or more amplitude signals of tracked positions.

29. The method of any one of claims 1 to 28 in which an interface modulates the signal transmitted by each transmitter with a different time offset.

30. The method of claim 29 in which the frequency modulation of each signal is the same.

31. The method of claim 29 or claim 30 in which the pen detects a signal being the time offset signal transmitted from each transmitter in turn.

32. The method of any one of claim 29 to claim 31 comprising processing each time offset signal to provide a signal which is used to indicate the coarse position of the pen.

33. The method of any one of claims 29 to 32 comprising generating, by the pen, in a signal sequence for each time offset transmitted signal, to produce one or more amplitude signals.

34. The method of claim 33 wherein the one or more amplitude signals is used, in accordance with their associated time offset, to determine a coarse location of the pen, and transmit said coarse location to the interface.

35. The method of claim 34 in which the pen transmits the one amplitude signal for each time offset to the interface.

36. The method of claim 35 in which the interface determines a coarse location for the pen in dependence thereon, and compare said coarse location to an accurate location.

37. The method according to claim 36 in which the interface compares the one or more amplitude signals to one or more amplitude signals of tracked positions.

38. A method for a device for an interactive display system, the device providing a contact point at an interactive surface of the system, the device receiving a wireless signal, and transmitting a wireless signal responsive to detection of receipt of the wireless signal, wherein the device is activated to transmit the wireless signal when it is located within a certain proximity of the interactive surface.

39. The method of claim 38 wherein the receipt of the wireless signal energizes the device.

40. The method of claim 38 or claim 39 wherein the receipt of the wireless signal comprises detecting a wireless signal which is provided by the system in addition to a wireless signal for detecting a contact point.

41. The method of any one of claims 38 to 40 wherein the device receives a plurality of wireless signals.

42. The method of claim 41 wherein the device determines an approximate position relative to the display surface on detection of the plurality of wireless signals, and provides an indication of said approximate position in the transmitted wireless signal.

43. The method of claim 41 wherein the device includes an indication of the received wireless signals in the transmitted wireless signals, so that the transmitted wireless signals can be used to determine a location of the device relative to the interactive surface.

44. An interactive display system comprising circuitry for detecting a contact point provided by a pointing input or a touch input at an interactive surface thereof, the system comprising circuitry for receiving data associated with a contact point; circuitry for determining if a wireless signal is received; circuitry for, in dependence on receipt of a wireless signal, identifying said data as touch data or pen data, wherein the pen is adapted to be activated to transmit a wireless signal when pen circuitry determines it is located within a certain proximity of the interactive surface.

45. The interactive display system of claim 44 wherein the pen includes circuitry for transmitting a wireless signal responsive to an interrogation signal.

46. The interactive display system of claim 44 or 45 wherein an interactive system associated with the interactive surface includes circuitry adapted to transmit an infra-red illumination field on the interactive surface, additional to any infra-red signal associated with detection of a contact point, for enabling detection of the pen providing the contact point.

47. The interactive display system of claim 46 wherein the pen is adapted to include circuitry to detect an infra-red signal associated with said infra-red illumination field.

48. The interactive display system of claim 46 or claim 47 wherein the pen is adapted to include circuitry which is energized by an infra-red signal associated with said infra-red illumination field.

49. The interactive display system of any one of claims 46 to 48 wherein the pen is adapted to include circuitry to transmit a wireless signal upon detection or receipt of said infra-red signal.

50. The interactive display system of any one of claims 46 to 49 wherein the pen is adapted to include circuitry to transmit a wireless signal representing the detection of an infra-red signal generated for detecting a contact point.

51. The interactive display system of any one of claims 44 to 50 wherein the interactive surface is arranged for detection of a contact point provided by touch inputs.

52. The interactive display system of any one of claims 44 to 51 further comprising circuitry to identify data as pen data if a wireless signal is received.

53. The interactive display system of any one of claims 44 to 52 further comprising circuitry to identify data as touch data if a wireless signal is not received.

54. The interactive display system of claim 52 or claim 53 wherein on identification, circuitry is adapted to transmit the data for further processing.

55. The interactive display system of any one of claims 44 to 54 further comprising delay circuitry wherein transmission of said data for further processing of the data is delayed whilst determination is made as to whether a wireless signal is received.

56. The interactive display system of any one of claims 44 to 55 further comprising flag setting circuitry for setting one or more flag bits associated with said data.

57. The interactive display system of claim 56 wherein the one or more flag bits may be a single bit, the state of which indicates touch data or pen data.

58. The interactive display system of any one of claims 44 to 57 including circuitry for identifying data associated with multiple contact points as being provided by touch inputs or device inputs, further comprising circuitry for determining a location of any device, and circuitry for comparing the location of such device to the location of a contact point.

59. The interactive display system of any one of claims 44 to 58 in which an interface is adapted to include circuitry to transmit wireless infra-red signals in a plurality of infra-red transmitters, the signals from the respective infra-red transmitters illuminating the interactive surface with an infra-red signal.

60. The interactive display system of claim 59 in which the central axis of each infra-red transmitter is offset from the central axis of each other infra-red transmitter.

61. The interactive display system of claim 59 or claim 60 in which a pen positioned on the interactive surface includes circuitry for receiving a signal from one or more infra-red transmitters, and processing the received signals.

62. The interactive display system of claim 61 in which the pen is adapted to include circuitry to transmit a signal to the interface, which signal is indicative of a coarse location of the pen.

63. The interactive display system of claim 62 in which the signal transmitted from the pen is an indication of the amplitude of the signal received from each transmitter.

64. The interactive display system of any one of claims 59 to 63 in which an interface is adapted to modulate the signal transmitted by each transmitter with a different frequency.

65. The interactive display system of claim 64 in which the time offset of each signal is the same.

66. The interactive display system of claim 64 or claim 65 in which the pen is adapted to include circuitry to detect a composite signal being the signal transmitted from each transmitter.

67. The interactive display system of claim 66 in which the pen is adapted to include circuitry to process the composite signal to provide one or more signals indicating the coarse position of the pen.

68. The interactive display system of claim 67 in which the one or more signals are one or more amplitude signals representing the amplitude of the signals received at the pen from each transmitter.

69. The interactive display system of claim 68 in which the pen is adapted to include circuitry to determine a coarse location of the pen based on said signals, and transmit said coarse location to the interface.

70. The interactive display system of claim 68 or claim 69 in which the pen is adapted to include circuitry to transmit the one or more amplitude signals representing the amplitude of the signals received at the pen from each transmitter to the interface.

71. The interactive display system of claim 70 in which the interface is adapted to include circuitry to determine a coarse location for the pen in dependence thereon, and compare said coarse location to an accurate location.

72. The interactive display system of claim 71 in which the interface is adapted to include circuitry to compare the one or more amplitude signals to one or more amplitude signals of tracked positions.

73. The interactive display system of any one of claims 44 to 72 in which an interface is adapted to include circuitry to modulate the signal transmitted by each transmitter with a different time offset.

74. The interactive display system of claim 73 in which the frequency modulation of each signal is the same.

75. The interactive display system of claim 73 or claim 74 in which the pen is adapted to include circuitry to detect a signal being the time offset signal transmitted from each transmitter in turn.

76. The interactive display system of any one of claim 73 to claim 75 in which the pen is adapted to include circuitry to process each time offset signal to provide a signal which is used to indicate the coarse position of the pen.

77. The interactive display system of any one of claims 73 to 76 in which a signal is generated by the pen in sequence for each time offset transmitted signal, to produce one or more amplitude signals.

78. The interactive display system of claim 77 wherein the one or more amplitude signals is used, in accordance with their associated time offset, to determine a coarse location of the pen, and transmit said coarse location to the interface.

79. The interactive display system of claim 78 in which the pen is adapted to include circuitry to transmit the one amplitude signal for each time offset to the interface.

80. The interactive display system of claim 79 in which the interface is adapted to include circuitry to determine a coarse location for the pen in dependence thereon, and compare said coarse location to an accurate location.

81. The interactive display system of claim 80 in which the interface is adapted to include circuitry to compare the one or more amplitude signals to one or more amplitude signals of tracked positions.

82. A device for an interactive display system, the device providing a contact point at an interactive surface of the system, the device comprising circuitry for receiving a wireless signal, and circuitry for transmitting a wireless signal responsive to detection of receipt of the wireless signal, wherein the device is activated to transmit the wireless signal when circuitry determines it is located within a certain proximity of the interactive surface.

83. The device of claim 80 wherein including circuitry such that the receipt of the wireless signal energizes the device.

84. The device of claim 82 or claim 83 wherein the receipt of the wireless signal comprises circuits for detecting a wireless signal which is provided by the system in addition to a wireless signal for detecting a contact point.

85. The device of any one of claims 82 to 84 wherein the device circuitry receives a plurality of wireless signals.

86. The device of claim 85 wherein the device includes circuitry to determine its approximate position relative to the interactive surface on detection of the plurality of wireless signals, and circuitry to provide an indication of said approximate position in the transmitted wireless signal.

87. The device of claim 85 wherein the device includes circuitry for including an indication of the received wireless signals in the transmitted wireless signal, so that the transmitted wireless signals can be used to determine a location of the device relative to the interactive surface.
